(19) United States
(12) Patent Application Publication
(10) Pub. No.: US 2026/0160246 A1
(43) Pub. Date: Jun. 11, 2026

(54) SYSTEMS FOR VALVE ASSEMBLIES, VALVE MEMBERS, AND VALVE SEAT BODIES

(71) Applicant: SPM Oil & Gas Inc., Fort Worth, TX (US)

(72) Inventors: Sergio Vega, Fort Worth, TX (US); Chiawei Steven Su, Arlington, TX (US); Ralph E. Harris, Fort Worth, TX (US)

(73) Assignee: SPM Oil & Gas Inc., Fort Worth, TX (US)

(21) Appl. No.: 18/972,161

(22) Filed: Dec. 6, 2024

(51) Int. Cl. F04B 53/10; F16K 15/02; F16K 25/00

(52) U.S. Cl. CPC F04B 53/1025; F16K 25/00; F16K 15/025

(57) ABSTRACT

At least one aspect of the present disclosure is directed to systems and methods for a valve assembly for a fluid end of a high pressure fracturing pump. The valve assembly may include a valve member having an engagement surface, the valve member movable between a closed position and an open position. The valve assembly may include a valve seat body including a seating surface that is engaged with the engagement surface of the valve member in the closed position, the seating surface including a recess therein. The valve assembly may include an insert disposed within the recess such that at least a portion of an outer surface of the insert that faces a surface of the recess is spaced apart therefrom when the valve member is in the open position.

### TECHNICAL FIELD

The present implementations relate generally to reciprocating pumps, and more particularly to valve assemblies for reciprocating pumps.

### BACKGROUND

Valve assemblies are used in various technologies and machinery to regulate fluid flow. For example, some valve assemblies may be used in reciprocating pump assemblies to deliver pressurized fluid through reciprocating motion.

For example, U.S. Pat. No. 11,761,441B1 describes a valve member for a spring-loaded valve assembly including a top portion having a spring retaining recess, the spring retaining recess extending into the top portion to form a void space, the void space to receive at least one coil of a spring, the spring retaining recess having a recess diameter that is smaller than a top portion diameter, wherein the recess diameter is larger than a rest diameter of a spring base including the coil, the spring retaining recess blocking expansion of the at least one coil when the spring is compressed. The valve member also includes a bottom portion coupled to the top portion. The valve member further includes a sealing element positioned axially below a shoulder of the top portion and legs coupled to the bottom portion.

In operations such as hydraulic fracturing, such valve assemblies have a limited life due to harsh and high pressure operating conditions. There is a need to increase the operational performance of valve assemblies, valve members, and valve seat bodies.

### SUMMARY

According to a first aspect, there is provided a valve assembly for a fluid end of a high pressure fracturing pump. The valve assembly includes a valve member having an engagement surface, the valve member movable between a closed position and an open position. The valve assembly also includes a valve seat body having a seating surface that is engaged with the engagement surface of the valve member when in the closed position. The seating surface includes a recess therein configured to receive an insert disposed within the recess such that at least a portion of an outer surface of the insert that faces a surface of the recess is spaced apart therefrom when the valve member is in the open position.

According to a second aspect, there is provided a valve seat body for a fluid end of a high pressure fracturing pump. The valve seat body includes an inner surface forming a fluid bore and an outer surface configured to be supported within the fluid end. The outer surface includes a first vertical surface, a second surface extending from the first vertical surface, and a chamfered surface angularly extending from the second surface in a direction away from the first vertical surface. The chamfered surface may be formed having a length greater than a length of the second surface.

According to a third aspect, there is provided a valve member for a fluid end of a high pressure fracturing pump. The valve member includes a valve seat body having a head portion and a tail portion. The head portion includes an engagement surface configured to contact a seating surface of a valve seat body, the engagement surface including a metallic strike face and an annular cavity. The head portion may include a seal disposed in the annular cavity and a plurality of teeth extending into the annular cavity configured to engage the seal. The teeth are configured to grip the seal to resist expansion of the seal when the valve seat body is in a closed position.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is an elevational view of a reciprocating pump assembly having a power end coupled to a fluid end, in accordance with present implementations.

FIG. 2 is a cross-sectional view of the fluid end illustrated in FIG. 1 illustrating inlet and outlet valve assemblies, in accordance with present implementations.

FIG. 3 is an enlarged view of the inlet valve assembly illustrated in FIG. 2, in accordance with present implementations.

FIG. 4 is a cross-sectional view of an embodiment of a valve seat of a valve assembly, in accordance with present implementations.

FIG. 5 is an enlarged view of a portion of the valve seat of FIG. 4, in accordance with present implementations.

FIG. 6 is a cross-sectional view of an embodiment of a valve member of a valve assembly, in accordance with present implementations.

FIG. 7 is a cross-sectional view of the valve member of FIG. 6 with a seal member removed from the valve member, in accordance with present implementations.

FIG. 8 is an enlarged view of a portion of the valve member of FIG. 7, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

In oilfield operations, reciprocating pumps are used for different applications such as fracturing subterranean formations, cementing wellbores, or treating the wellbore and/or formation. A reciprocating pump typically includes a power end and a fluid end. The fluid end is commonly formed of a one piece construction or a series of blocks secured together by rods. The fluid end includes an opening for receiving a plunger or plunger throw, an inlet passage, an outlet passage, and an access port. Reciprocating pumps are oftentimes operated at pressures of 10,000 pounds per square inch (psi) and upward to 25,000 psi and at rates of up to 1,000 strokes per minute or even higher during fracturing operations. A reciprocating pump designed for fracturing operations is referred to as a frac pump.

During operation of a frac pump, a fluid is pumped into the fluid end through the inlet passage and out of the pump through the outlet passage. The inlet and outlet passages each include a valve assembly, which is a check type of valve that is opened by differential pressure of the fluid and allows the fluid to flow in only one direction. Various surfaces of the valve assembly may engage, including a valve seat body fixed into the inlet or outlet passages within the fluid end and a valve member that moves cyclically relative to the valve seat body. In operation, the valve is operable between an open position, in which the valve member is spaced apart from the valve seat body to facilitate fluid flow through the valve, and a closed position, in which the valve member contacts and sealingly engages the valve seat body to prevent fluid flow.

During operation, repeated contact between the valve member and valve seat body can cause contact pressure resulting in wear or damage to various components of the valve assembly. For example, contact pressure caused by contact or engagement between a valve member and valve seat body can cause deformation or cracks in the valve member or valve seat body. In some examples, a valve member can include a seal to mitigate damage, but the engagement of the valve member and valve seat body can cause expansion of an outer diameter of the seal, which may disrupt the movement of the valve member within the valve assembly. Further, the pressure caused by contact between the valve seat body and a fluid end or in inlet can cause damage to the valve seat body (e.g., fatigue cracks). Thus, there is a need to provide a valve assembly with a valve member and/or valve seat body having increased resistance to wear to address one or more of the foregoing issues.

Referring generally to the FIGURES, systems and methods described herein may be configured, designed, or otherwise arranged to implement a valve assembly for a fluid end of a high pressure fracturing pump. The valve assembly may include a valve member movable between a closed position and an open position. The valve assembly may include a valve seat body that is engaged with the valve member when the valve member is in the closed position. Various embodiments of the valve assembly, valve member, and/or valve seat body are further described herein.

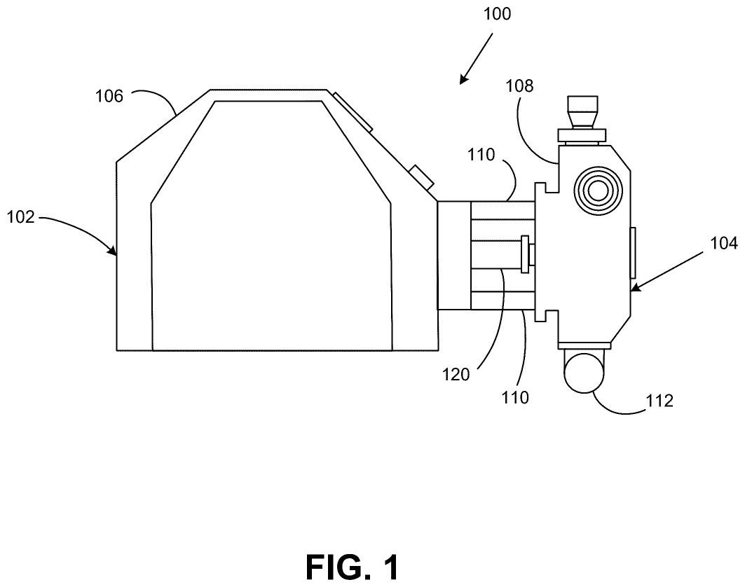

Referring to FIGS. 1-3, an illustrative embodiment of a reciprocating pump assembly 100 is presented. In FIGS. 1-3, the reciprocating pump assembly 100 includes a power end portion 102 and a fluid end portion 104 operably coupled thereto. The power end portion 102 includes a housing 106 in which a crankshaft (not shown) is disposed, the crankshaft is driven by an engine or motor (not shown). The fluid end portion 104 includes a fluid end block or fluid cylinder 108, which is connected to the housing 106 via a plurality of stay rods 110. In operation and as discussed in further detail below, the crankshaft reciprocates a plunger rod assembly 120 between the power end portion 102 and the fluid end portion 104. According to some embodiments, the reciprocating pump assembly 100 is freestanding on the ground, is mounted to a trailer for towing between operational sites, or is mounted to a skid.

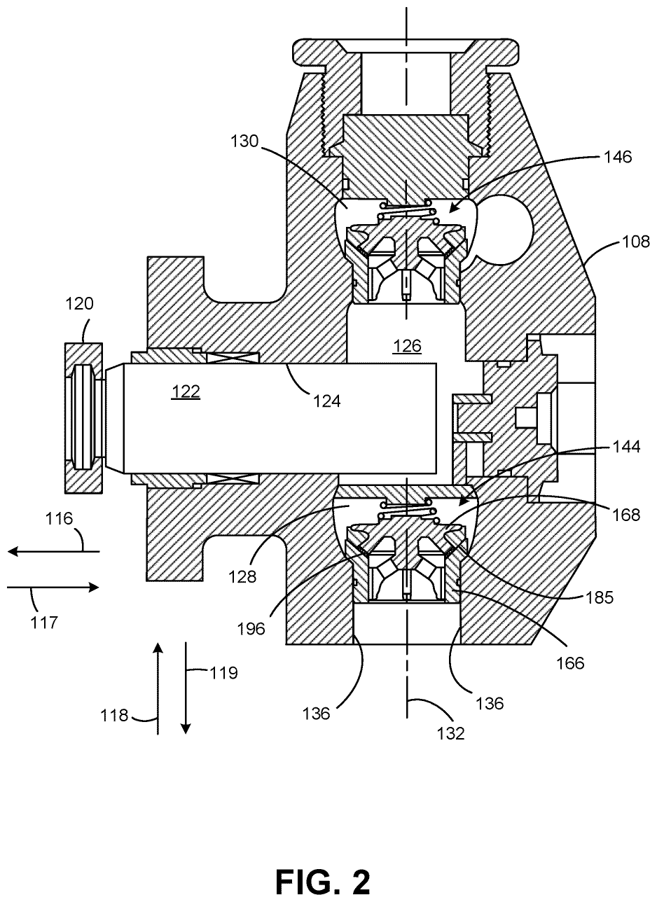

Referring to FIGS. 1 and 2, the plunger rod assembly 120 includes a plunger 122 extending through a bore 124 and into a pressure chamber 126 formed in the fluid cylinder 108. At least the bore 124, the pressure chamber 126, and the plunger 122 together may be characterized as a plunger throw. According to some embodiments, the reciprocating pump assembly 100 includes a plurality of plunger throws, such as three (i.e., a triplex pump assembly) or five (i.e., a quintuplex pump assembly); however, it should be understood that reciprocating pump assembly 100 may include a greater or fewer number of plunger throws.

In the embodiment illustrated in FIG. 2, the fluid cylinder 108 includes fluid inlet and outlet passages 128 and 130 formed therein, which are generally coaxially disposed along a fluid passage axis 132. As described in greater detail below, fluid is adapted to flow through the fluid inlet and outlet passages 128 and 130 and along the fluid passage axis 132.

In FIG. 2, an inlet valve assembly 144 is disposed in the fluid inlet passage 128 and an outlet valve assembly 146 is disposed in the fluid outlet passage 130. In the embodiment illustrated in FIG. 2, the valve assemblies 144 and 146 may be spring-loaded, which, as described in greater detail below, are actuated by at least a predetermined differential pressure across each of the valve assemblies 144 and 146.

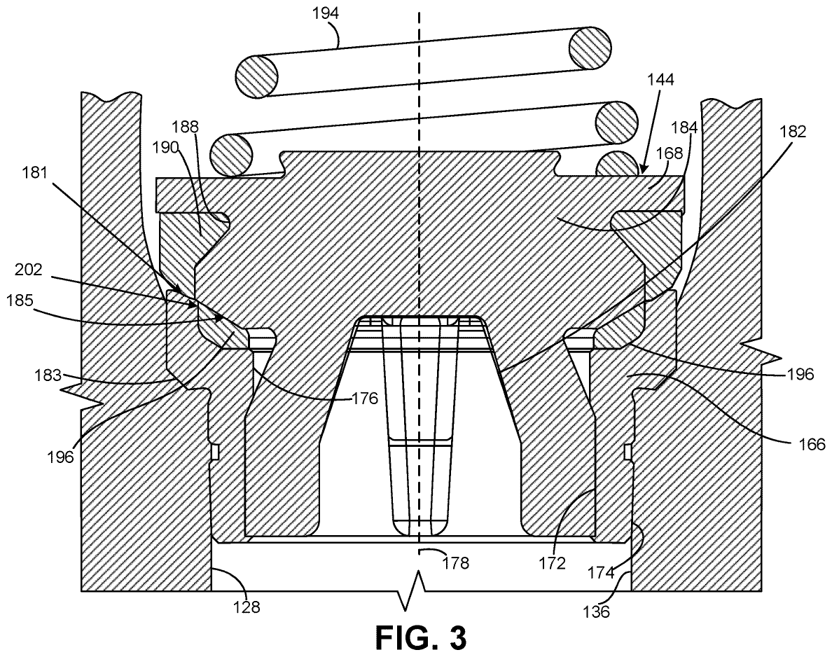

Referring to FIG. 3, the inlet valve assembly 144 includes a valve seat body 166 and a valve member 168 reciprocatingly engageable with the valve seat body 166. In the embodiment illustrated in FIG. 3, the valve seat body 166 with inner surface 172 and an opposing outer surface 174. The inner surface 172 forms a bore 176 along a valve seat axis 178 of the valve seat body 166, which is coaxial with the fluid passage axis 132 (FIG. 2) when the inlet valve assembly 144 is disposed in the fluid inlet passage 128. The outer surface 174 of the cylindrical body 170 contacts and is supported by an inside surface 136 of the fluid cylinder 108. In operation and as discussed in greater detail below, the valve member 168 is moveable between an open position and a closed position.

With continued reference to FIGS. 1-3, the valve member 168 includes a tail portion 182, from which a head portion 184 extends radially outward. An annular cavity 188 is formed in the head portion 184 and is configured to receive a seal 190 to sealingly engage at least a portion of the seating surface 181 of the valve seat body 166. In the embodiment illustrated in FIG. 3, the valve member 168 further includes a metallic strike face 185 configured to sealingly engage at least a portion of the seating surface 181. Collectively, the metallic strike face 185 and seal 190 form an engagement surface 202, which contacts or otherwise sealingly engages with the seating surface 181 when the valve member 168 is in a closed position. That is, the valve member 168 may include an engagement surface 202 to engage with the seating surface 181 of the valve seat body 166.

In the embodiment illustrated in FIG. 3, for example, the seal 190 is molded in place in the head portion 184. In other embodiments, the seal 190 is preformed and then attached to the head portion 184. According to some embodiments, the seal 190 is composed of one or more materials such as, for example, a deformable thermoplastic material, a urethane material, a fiber-reinforced material, carbon, glass, cotton, wire fibers, cloth, and/or any combination thereof. In other embodiments, the seal 190 is composed of a cloth, which is disposed in a thermoplastic material. According to some embodiments, the cloth includes carbon, glass, wire, cotton fibers, and/or any combination thereof. In yet other embodiments, the seal 190 is composed of at least a fiber-reinforced material, which can prevent or at least reduce delamination. According to embodiments disclosed herein, the seal 190 has a hardness of 95 A durometer or greater, or a hardness of 69 D durometer or greater based on the Rockwall Hardness scale. According to some embodiments, such as, for example, the embodiment illustrated in FIG. 2, the outlet valve assembly 146 may be identical to the inlet valve assembly 144 and therefore will not be described in further detail.

With continued reference to FIGS. 1-3, operation of the reciprocating pump assembly 100 is discussed. In operation, the plunger 122 reciprocates within the bore 124 for movement in and out of the pressure chamber 126. That is, the plunger 122 moves back and forth horizontally, as viewed in FIG. 2, away from and towards the fluid passage axis 132 in response to rotation of the crankshaft (not shown) that is enclosed within the housing 106 (FIG. 1). As the plunger 122 moves in the direction of arrow 116 (FIG. 2) out of the pressure chamber 126, the inlet valve 144 is opened. More particularly, as the plunger 122 moves away from the fluid passage axis 132 in the direction of arrow 116, the pressure inside the pressure chamber 126 decreases, creating a differential pressure across the inlet valve 144 and causing the valve member 168 to move upward in the direction of arrow 118, as viewed in FIGS. 2 and 3, relative to the valve seat body 166. As a result of the upward movement of the valve member 168, the spring 194 is compressed and the seal 190 separates from the seating surface 181 to move the valve member 168 to the open position (e.g., to allow fluid flow). Fluid entering through the fluid inlet passage 112 (FIG. 1) flows along the axis 132 and through the inlet valve 144, being drawn into the pressure chamber 126. To flow through the inlet valve 144, the fluid containing particulates flows through the bore 176 of the valve seat body 166 and along the valve seat axis 178. During the fluid flow through the inlet valve 144 and into the pressure chamber 126, the outlet valve 146 is in its closed position, with the seal 190 of the valve member 168 of the outlet valve 146 engaging the seating surface 181 of the valve seat body 166. Fluid continues to be drawn into the pressure chamber 126 until the plunger 122 is at the end of its stroke farthest away from the fluid passage axis 132. At this point, the differential pressure across the inlet valve 144 is such that the spring 194 of the inlet valve 144 begins to decompress and extend, forcing the valve member 168 of the inlet valve 144 to move downward in the direction of arrow 119, as viewed in FIGS. 2 and 3. As a result, the inlet valve 144 moves to and is otherwise placed in the closed position, with the seal 190 and the metallic strike face 185 of the engagement surface 202 sealingly engaging the seating surface 181 of the valve seat body 166.

With continued reference to FIGS. 1-3, as the plunger 122 moves in the direction of arrow 117 (FIG. 2) into the pressure chamber 126, the pressure within the pressure chamber 126 increases. The pressure increases until the differential pressure across the outlet valve 146 exceeds a predetermined set point, at which point the outlet valve 146 opens and permits fluid to flow out of the pressure chamber 126, along the fluid passage axis 132 through the outlet valve. As the plunger 122 reaches the end of its stroke towards the fluid passage axis 132 (i.e., its discharge stroke), the inlet valve 144 is positioned in the closed position, with the seal 190 and the metallic strike face 185 of the engagement surface 202 sealingly engaging the seating surface 181 (e.g., with the valve member 168 seated in the valve seat body 166). In some embodiments, the insert 196 may reduce and/or otherwise prevent the wear of the valve member 168 and/or the valve seat body 166. For illustrative purposes, the insert 196 is only shown as being positioned in the valve seat body 166; however, it should be appreciated that the insert 196 may be positioned in both the valve member 168 and the valve seat body 166 for various purposes (e.g., to prevent wear). According to some embodiments, the insert is formed of a tungsten carbide material.

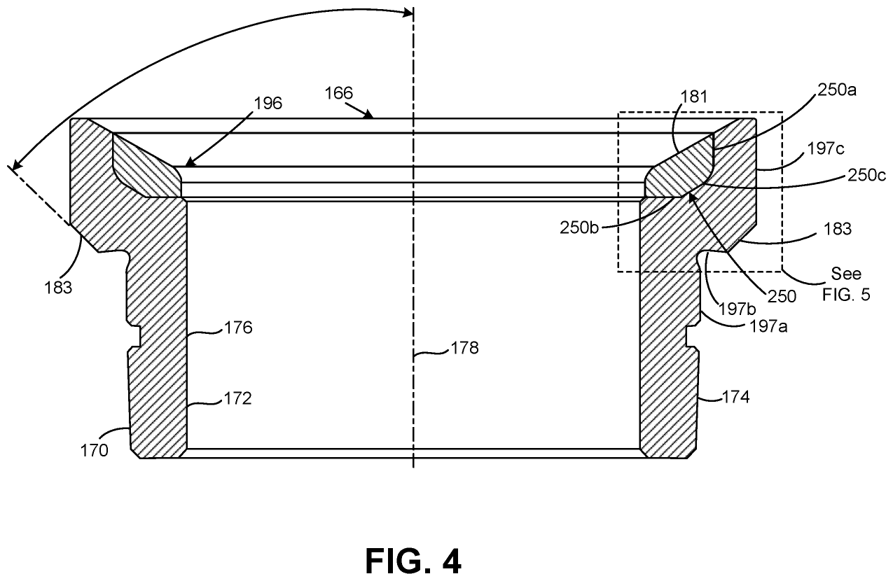

In the embodiment illustrated in FIG. 4, the seating surface 181 includes a recess 250 (e.g., cavity, annular groove) to receive or retain the insert 196 at least partially therein. In some embodiments, the recess 250 may be formed in the valve seat body 166 and have one or more sidewalls 250a, 250b and 250c. In some embodiments, the insert 196 may positioned and/or otherwise designed to contact one or more of the sidewalls 250a, 250b and/or 250c of the recess 250 and/or not contact one or more of the sidewalls 250a, 250b and/or 250c depending on whether the valve member 168 is in the open position or the closed position.

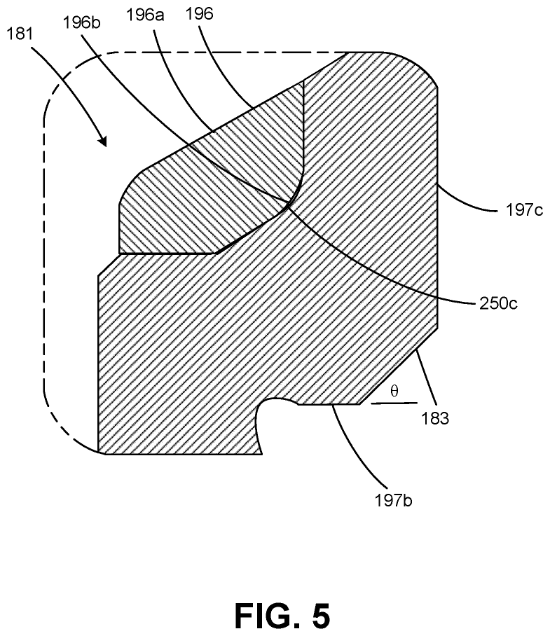

Referring to the embodiment illustrated in FIGS. 4-5, the outer surface 174 of the valve seat body 166 includes a first surface 197a, a second surface 197b extending from the first surface 197a, and chamfered surface 183 extending angularly from the second surface 197b and to a third surface 197c. According to embodiments disclosed herein, the first surface 197a extends in a generally vertical direction (i.e., generally parallel to axis 178), although it should be understood that the first surface 197a may extend otherwise (i.e., in a direction not parallel to axis 178). In addition, while the embodiment illustrated in FIGS. 4-5 illustrate the second surface 197b extending radially outward from the first surface 197a in a generally horizontal direction (i.e., generally perpendicular to axis 178), it should be understood that the horizontal surface 197b may be otherwise configured (i.e., radially extending from the first surface 197a in a non-horizontal direction).

In some embodiments, the chamfered surface 183 is formed having a length greater than a length of the second surface 197b. Further, in other embodiments, the length of the chamfered surface 183 can be less than the length of the third vertical surface 197c. In some embodiments, the chamfered surface 183 can extend linearly between the second surface 197b and the third vertical surface 197c. According to some embodiments, the chamfered surface 183 may linearly extend at an angle θ of about 45 degrees; however, it should be understood that the angle θ may be otherwise configured (i.e., other angles may be used).

According to some embodiments, the recess 250 on the inner surface 172 of the valve seat body 166 may be located a first distance from a central axis (e.g., axis 178) of the valve seat body 166. Further, the chamfered surface 183 may be located at a second distance from the central axis 178. According to some embodiments, the second distance of the chamfered surface 183 may be greater than the first distance of the recess 250. That is, various outer diameters of the chamfered surface 183 of the outer surface 174 may be greater than inner diameters of the recess 250.

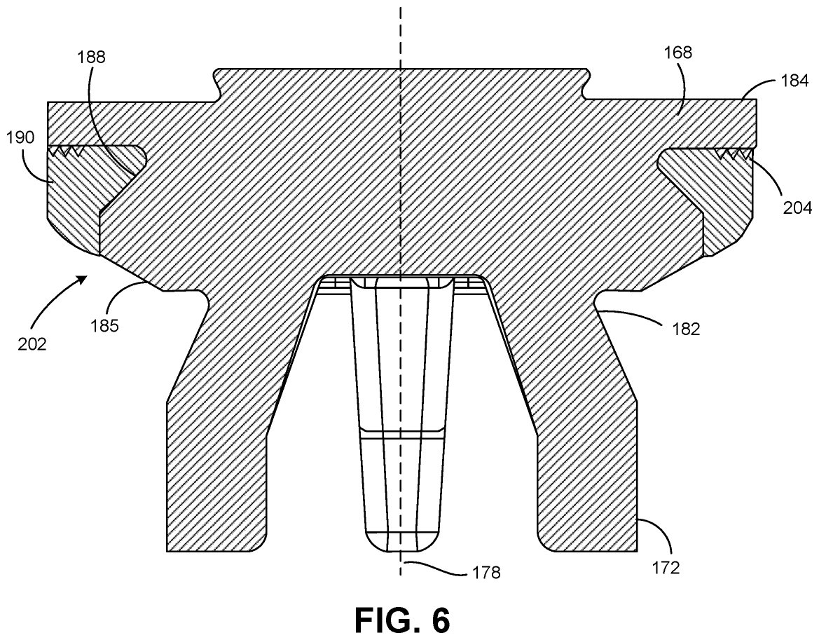

According to some embodiments, the seating surface 181 engages with or contacts the engagement surface 202 (FIG. 6) when the valve member 168 is in the closed position. Further, the insert 196 may include an upper surface 196a which engages with or contacts the engagement surface 202 when the valve member 168 is in the closed position. For example, the upper surface 196a may form a portion of the seating surface 181. In some embodiments, the upper surface 196a may be coplanar or flush with the seating surface 181.

Still referring to FIGS. 4-5, when the valve member 168 is in an open position, at least a portion of the insert 196 is configured to be spaced apart from a surface of the recess 250. For example, outer surface 196b of the insert 196 may face one or more of the sidewalls 250a, 250b and 250c of the recess 250 and be spaced apart therefrom. That is, the insert 196 can include a curved inner radius (e.g., outer surface 196b), and one portion of the curved outer radius may contact the sidewall 250c (also referred to herein as surface 250c) while another portion of the curved outer radius may be spaced apart from the sidewall 250c when the valve member 168 is in the open position. In operation, the sidewall or surface 250c of the recess 250 being spaced apart from the insert 196 (e.g., by the recess 250 having a shoulder chamfer) acts to reduce stress caused by contact between the seating surface 181 and engagement surface 202.

In some embodiments, operational forces applied to and/or otherwise acting on the insert 196 (e.g., the tensile and compressive forces) may affect the size, shape or placement of the insert 196. For example, contact pressure via contact between the engagement surface 202 and seating surface 181 caused by the valve member 168 moving to a closed position may compress the insert 196 and/or alter various dimensional properties or surfaces of the insert 196. In some embodiments, the valve member 168 moving to the closed position causes at least a portion of the outer surface 196b previously spaced apart from the sidewall or surface 250c to contact the sidewall or surface 250c. For example, the portion of the insert 196 may engage with or contact the recess 250 when the valve member 168 is in the closed positions.

Referring to FIG. 6, the seal 190 of the valve member 168 is positioned adjacent to the metallic strike face 185. In particular, the metallic strike face 185 and the seal 190 disposed in the annular cavity 188 collectively form the engagement surface 202. According to some embodiments, the engagement surface 202 may be configured to sealingly engage at least a portion of the seating surface 181. According to some embodiments, a length of the metallic strike face 185 along the engagement surface 202 is greater than a length of the seal 190 along the strike surface. For example, the seal 190 may form 45% of the engagement surface 202, and the metallic strike face 185 may form 55% of the engagement surface 202 (e.g., a urethane to metal strike face ratio of 45 to 55). In some embodiments, the seal 190 forms 37% of the engagement surface 202, and the metallic strike face 185 forms 63% of the engagement surface 202 (e.g., a urethane to metal strike face ratio of 37 to 63).

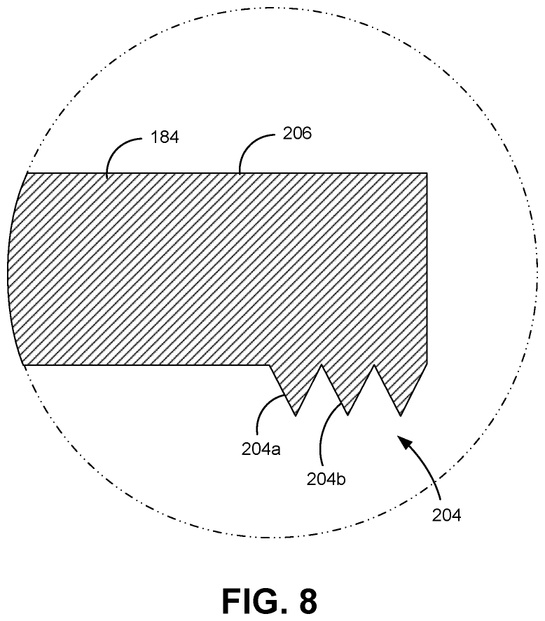

According to some embodiments, the seal 190 is composed of one or more materials such as, for example, a urethane material, a fiber-reinforced material, carbon, glass, cotton, wire fibers, cloth, a deformable thermoplastic material, and/or any combination thereof. For example, the seal 190 may be a urethane seal. In some embodiments, the seal 190 may be an annular ring or an o-ring. As further described herein regarding FIG. 8, the head portion 184 of valve member 168 may include a plurality of teeth 204 configured to engage the seal 190.

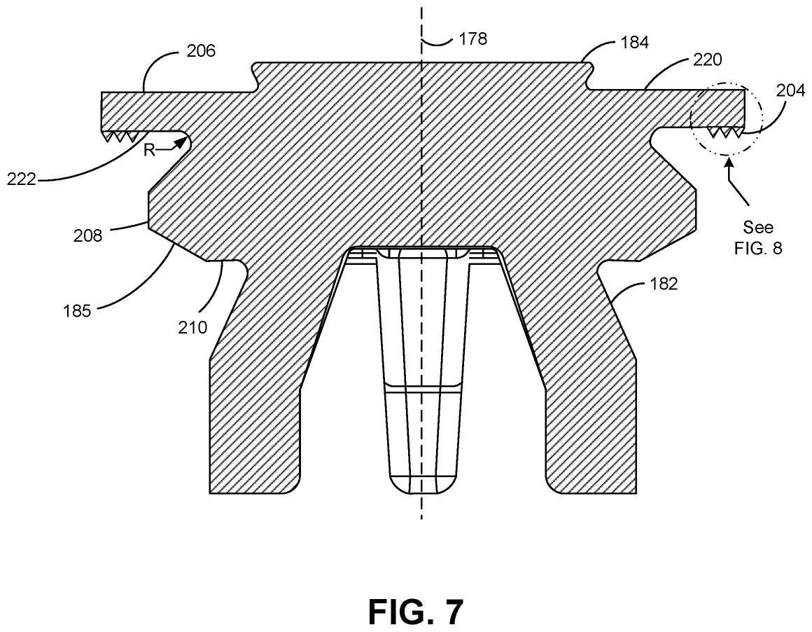

Referring specifically to FIG. 7, the metallic strike face 185 may be formed on an outer surface 206 of the valve member 168. In some embodiments, the metallic strike face 185 may angularly extend from a vertical surface 208 of the outer surface 206 of the valve member 168. For example, the metallic strike face 185 may extend from vertical surface 208 at an angle configured to cause the metallic strike face 185 to engage with the seating surface 181, such as a sixty degree angle relative to the vertical surface 208. In some embodiments, the metallic strike face 185 may be formed having a length greater than the length of the vertical surface 208. In some embodiments, the length of the metallic strike face 185, angle of the metallic strike face 185 relative to the vertical surface 208, and/or length of the vertical surface 208 may be selected or configured to reduce stress (e.g., cyclic stress) caused by movement of the valve member 168 to and from the closed positions and open positions.

According to some embodiments, the head portion 184 of valve member 168 may include a top cap 220. For example, the top cap 220 may include upper surface 206 and a lower surface 222 including the plurality of teeth 204 and forming a portion of the annular cavity 188. In some embodiments, a thickness of the top cap 220 is at least twice a radius of a curved surface of the annular cavity 188 formed between the lower surface 222 of the top cap 220 and the vertical surface 208. The thickness of the top cap 220 may refer to a dimension of the top cap 220 between the upper surface 206 and the lower surface 222. In some embodiments, the thickness of the top cap 220 being at least twice the radius of the curved surface of the annular cavity 188 may increase bending stiffness and prevent fatigue cracks caused by movement of the valve member 168.

According to some embodiments, the outer surface 206 of the valve member 168 may include a horizontal surface 210. In some embodiments, the metallic strike face 185 angularly extends from the horizontal surface 210. For example, the metallic strike face 185 may extend from the horizontal surface 210 of the outer surface 206 of the valve member 168 at an angle of thirty degrees relative to the horizontal surface 210. In some embodiments a length of the metallic strike face 185 is greater than a length of the horizontal surface 210.

Referring now to FIGS. 7-8, the outer surface 206 of the valve member 168 may include one or more teeth 204. Generally, the teeth 204 engage the seal 190 by extending into or gripping the seal 190. In some embodiments, the plurality of teeth 204 extend (e.g., downward) into annular cavity 188 to engage with the seal 190. In some examples, the teeth 204 may grip the seal 190 to resist expansion of the seal 190 when the valve seat body 166 is in a closed position. Expansion of the seal 190 may refer to urethane outer diameter expansion of the seal 190 caused by compression or contact with the seating surface 181. That is, the teeth 204 may be configured to resist outer diameter expansion or deformation of the seal 190.

According to some embodiments, the valve member 168 may include any number of teeth 204. For example, the valve member 168 may have teeth 204 including a first tooth 204a and/or a second tooth 204b. In other examples, the valve member 168 may include one tooth, two teeth, three teeth, and so on. In some embodiments, the teeth 204 include a pointed or triangular cross section, which may engage with or grip the seal 190. For example, the teeth 204 may grip the seal 190 at a depth relative to a surface of the seal 190 and corresponding to a length of the teeth 204. In examples including multiple teeth, each of the teeth 204 may be evenly spaced relative to other teeth 204. Further, the teeth 204 may be concentric to axis 178 of the valve member 168. The teeth 204 may extend along an entire circumference of an outer surface 206 of the valve member 168, or may partially extend along such surfaces. In embodiments where the teeth 204 partially extend along the outer surface 206 of valve member 168, the teeth 204 may be placed at intervals.

Still referring to FIGS. 7-8, the teeth 204 may be formed having various shapes, dimensions, and/or configurations. In some embodiments, the teeth 204 are formed having triangular or pointed cross sections such that the teeth 204 may engage with the seal 190 (e.g., via the teeth 204 sinking into the seal 190). For example, as shown in FIG. 8, the teeth 204 may have a three-sided or triangular configuration with an included angle (e.g., an inner angle or interior angle, such as the angle between the points of teeth 204a and 204b), which can range from 5 degrees to 90 degrees. For example, the teeth 204 may have an included angle of 60 degrees.

### INDUSTRIAL APPLICABILITY

The disclosed embodiments may be applicable to any valve assemblies. For example, the disclosed embodiments may be applicable to or applied to valve seats or valve members in various applications, and may be applicable to various systems used to regulate fluid flow. For example, the disclosed embodiments may be applied to engines, compressors, pumps, and other fluid regulation systems used in industrial and commercial applications. Further, the disclosed embodiments may be applied to valve assemblies for high-pressure hydraulic fracturing pumps used in hydraulic fracturing systems.

As described herein, the disclosed embodiments may include valve assemblies with valve members and valve seat bodies having features (e.g., teeth) and/or configurations (e.g., dimensions of surfaces, materials, etc.) to improve wear resistance or reduce damage caused by contact pressure and cyclic stress. For example, the length of the metallic strike face 185 along the engagement surface 202 may be greater than a length of the seal 190 along the strike surface (e.g., a urethane to metal strike face ratio of 45 to 55, 37 to 63, etc.) to increase the area of the engagement surface 202 that is formed by metallic strike face 185 and reduce contact pressure or stress caused by contact with seating surface 181. Further, the teeth 204 of the valve member 168 may engage with the seal 190 to prevent deformation (e.g., outer diameter expansion) of the seal 190 that may interfere with movement of the valve member 168 between open/closed positions.

In another example, the thickness of the top cap 220 may be selected or configured to increase bending stiffness and reduce cracking of the top cap 220 caused by repeated motion of the valve member 168 between open and closed positions. Further, the insert 196 may include upper surface 196a having a radius such that a portion of insert 196 (e.g., outer surface 196b) is spaced apart from the surface of the recess 250 when the valve member 168 is in the open position, and the portion of insert 196 can bend and contact the surface of the recess 250 to dampen contact pressure when the valve member 168 moves to the closed position. In another example, the insert 196 being flush with another portion of valve seat body 166 forming the seating surface 181 may reduce shearing or nibbing of the seal 190 caused by movement of the valve member 168 to the closed position. Further still, the recess 250 having an inner radius or shoulder chamfer (e.g., sidewall or surface 250c) being spaced apart from a curved radius or lower surface 196b of the insert 196 may reduce stress and/or deformation caused by contacting surfaces of the valve assembly 144.

By using the systems for valve assemblies, valve members, and valve seat bodies described herein to regulate fluid flow in a reciprocating pump system used for hydraulic fracturing, the operational performance of valve assemblies may be improved by reducing or compensating for stress within elements of the valve assemblies causing damage or deformation (e.g., fatigue cracks). Overall, the systems described herein provide improvements to valve assemblies, valve members, and valve seat bodies used in hydraulic fracturing operations and in various other applications.

What is claimed is:

1. A valve assembly for a fluid end of a high pressure fracturing pump, the valve assembly comprising:
a valve member having an engagement surface, the valve member movable between a closed position and an open position;
a valve seat body including a seating surface that is engaged with the engagement surface of the valve member in the closed position, the seating surface including a recess therein; and
an insert disposed within the recess such that at least a portion of an outer surface of the insert that faces a surface of the recess is spaced apart therefrom when the valve member is in the open position.

2. The valve assembly of claim 1, wherein the portion of the outer surface of the insert contacts the surface of the recess when the valve member is in the closed position.

3. The valve assembly of claim 1, wherein the insert is formed of a tungsten carbide.

4. The valve assembly of claim 1, wherein the recess is an annular groove configured to retain the insert.

5. The valve assembly of claim 1, wherein an upper surface of the insert forms at least a portion of the seating surface that is engaged with the valve member in the closed position, and wherein the upper surface is coplanar with the seating surface.

6. A valve seat body for a fluid end of a high pressure fracturing pump, the valve seat body comprising:
an inner surface forming a fluid bore and an outer surface configured to be supported within the fluid end;
wherein the outer surface includes a first vertical surface, a second surface extending from the first vertical surface, and a chamfered surface angularly extending from the second surface in a direction away from the first vertical surface, the chamfered surface formed having a length greater than a length of the second surface.

7. The valve seat body of claim 6, wherein the outer surface comprises a third vertical surface, and wherein the length of the chamfered surface is less than a length of the third vertical surface.

8. The valve seat body of claim 7, wherein the chamfered surface linearly extends between the second surface and the third vertical surface.

9. The valve seat body of claim 6, further comprising a recess on the inner surface located a first distance from a central axis of the valve seat body, wherein the chamfered surface is located at a second distance from the central axis, and wherein the second distance of the chamfered surface is greater than the first distance of the recess.

10. The valve seat body of claim 6, wherein the chamfered surface angularly extends from the second surface at an angle of 45 degrees.

11. A valve member for a fluid end of a high pressure fracturing pump, the valve member comprising:
a valve member body including a head portion and a tail portion, the head portion including an engagement surface configured to contact a seating surface of a valve seat, the engagement surface including a metallic strike face and an annular cavity;
a seal disposed in the annular cavity; and
a plurality of teeth extending into the annular cavity configured to engage with the seal, the teeth gripping the seal to resist expansion of the seal when the valve member is in a closed position.

12. The valve member of claim 11, wherein the seal is a urethane seal comprising an annular ring.

13. The valve member of claim 11, wherein the plurality of teeth comprise at least a first tooth and a second tooth, and wherein the first tooth and the second tooth are concentric with an axis of the valve member.

14. The valve member of claim 11, wherein the plurality of teeth comprise an included angle of 60 degrees.

15. The valve member of claim 11, wherein the metallic strike face is formed on an outer surface of the valve member and angularly extends from a vertical surface of the outer surface of the valve member, the metallic strike face formed having a length greater than the length of the vertical surface, and wherein the seal is positioned adjacent to the metallic strike face.

16. The valve member of claim 15, wherein the head portion comprises a top cap, and wherein a thickness of the top cap is at least twice a radius of a curved surface of the annular cavity formed between a lower surface of the top cap and the vertical surface.

17. The valve member of claim 15, wherein a length of the metallic strike face along the engagement surface is greater than a length of the seal along the engagement surface.

18. The valve member of claim 15, wherein the seal forms 45% of the engagement surface, and wherein the metallic strike face forms 55% of the engagement surface.

19. The valve member of claim 15, wherein the seal forms 37% of the engagement surface, and wherein the metallic strike face forms 63% of the engagement surface.

20. The valve member of claim 15, wherein the metallic strike face angularly extends from a horizontal surface on the outer surface of the valve member, and wherein a length of the metallic strike face is greater than a length of the horizontal surface.
